(19) United States
(12) Patent Application Publication
(10) Pub. No.: US 2007/0243290 A1
(43) Pub. Date: Oct. 18, 2007

(54) Method of tailoring infant formulas to individual nutritional needs prior to use

(76) Inventors: Melody Thompson, Columbus, OH (US); Sandra E. Weida, Delaware, OH (US); Bridget Barrett-Reis, Dublin, OH (US); Terrence B. Mazer, New Albany, OH (US)

Correspondence Address: ROSS PRODUCTS DIVISION OF ABBOTT LABORATORIES;DEPARTMENT 108140-DS/1, 625 CLEVELAND AVENUE, COLUMBUS, OH, 43215-1724, US

(21) Appl. No.: 11/406,091

(22) Filed: Apr. 18, 2006

(51) Int. Cl. A23L 1/30

(52) U.S. Cl. 426/72

(57) ABSTRACT

Disclosed is a method of tailoring infant formulas to individual nutrition needs prior to use. The method comprises (A) determining the desired volume and optimal caloric density of a formula to be fed to a preterm or low birth weight infant; (B) obtaining a plurality of base infant formulas, all in liquid form, comprising fat, protein, carbohydrate, vitamins, and minerals, each of which has an osmolality of from about 200 to about 360 mOsm/kg water and a different caloric density within a range of from about 609 to about 1082 kcal/L; (C) selecting two of the base liquid formulas having a caloric density value above and below the optimal caloric density, (D) calculating the volume of each selected base formula needed to produce the desired volume of an infant formula blend having the optimal caloric density; (E) combining the calculated volumes to produce a an isotonic blend having the desired feeding volume and optimal caloric density. The formula is then fed to the preterm or low birth weight infant. Also disclosed is a hypercaloric infant formula suitable for use in the disclosed method, and infant formula kits comprising the plurality of base formulas and a device (e.g. calculator, computer program, chart with precalculated blend volumes) for calculating blend volumes.

### TECHNICAL FIELD

The present invention relates to a method of tailoring infant formulas to individual nutritional needs prior to use, especially in hospitals or other institutional settings. The present invention also relates to isotonic hypercaloric infant formulas for use in such methods.

### BACKGROUND OF THE INVENTION

Infant formulas are commonly used today to provide supplemental or sole source nutrition early in life. These formulas contain protein, carbohydrate, fat, vitamins, minerals, and other nutrients. They are commercially available as powders, ready-to-feed liquids, and liquid concentrates.

There are currently a variety of commercially available infant formulas, each one designed to meet the specific nutritional needs of a particular infant group. Milk-based infant formulas, for example, represent the majority of commercially available infant formulas. Soy-based formulas also represent a large portion of the infant formula market by offering an alternative to milk-based formulas, especially in milk-intolerant infants. Lactose-free formulas are also available and can be useful in those infants with lactose sensitivity. Infant formulas with amino acids or partially hydrolyzed proteins are also available for certain infants.

Infant formulas are also categorized by caloric densities. Formulas designed for term infants, for example, have caloric densities ranging from about 676 kcal/L (20 kcal/fl. oz) to about 812 kcal/L (24 kcal/fl. oz). Formulas currently designed for preterm or low birth weight infants generally provide from about 778 kcal/L (23 kcal/fl. oz.) to about 812 kcal/L (24 kcal/fl oz). Most preterm infants, following hospital discharge, are maintained on preterm discharge formulas.

In hospitals or other institutional settings, many preterm or other low birth weight infants require a series of infant formula changes to meet their changing nutritional and medical needs. Fluid restricted infants, for example, often require calorically dense formulas. Many of these infants require frequent changes to their nutritional formulas in view of fluctuating fluid status and medical needs, and often require specific caloric densities or nutrition profiles not currently provided by existing commercial product.

To accommodate the specific nutritional needs of individual infants, current practice in many hospitals is to rely upon the addition of various modular supplements to a base formula to achieve the desired caloric density or nutrition profile. These modular supplements often include specific carbohydrate, protein, or fat supplements, in powder or liquid form, that are added via several additions to a base formula to achieve the desired infant formula volume, caloric density, and nutrition profile. Calculating out and adding several modular ingredients, however, increases the risk of human error, is time consuming, and risks contamination during mixing, especially when using powdered modular supplements in a neonatal intensive care unit.

There is currently a need for an improved method of tailoring the caloric density of infant formulas prior to use, especially for preterm and low birth weight infants in an institutional setting, to reduce the risk of formulation contamination and human error, and to more readily meet the changing medical and dietary needs of young infants, especially preterm and low birth weight infants in an institutional setting.

It has been discovered herein, one such method to simplify the reformulation of an infant formula prior to use, wherein the method includes (A) determining the desired volume and optimal caloric density of a formula to be fed to a preterm or low birth weight infant; (B) obtaining a plurality of base infant formulas, all in liquid form, comprising fat, protein, carbohydrate, vitamins, and minerals, each of which has an osmolality of from about 200 to about 360 mOsm/kg water and a different caloric density within a range of from about 609 to about 1082 kcal/L; (C) selecting two of the base liquid formulas having a caloric density value above and below the optimal caloric density, (D) calculating the volume of each selected base formula needed to produce the desired volume of an infant formula blend having the optimal caloric density; (E) combining the calculated volumes of the selected base formulas to produce an infant formula blend having the desired volume, optimal caloric density, an osmolality of between 200 and 360 mOsm/kg water, and a caloric density of between 609 and 1082 kcal/L, and then (F) feeding the resulting formula to the preterm or low birth weight infant.

It has also been found herein that the described method can be performed using an infant formula kit comprising a plurality of the base infant formulas and a device for calculating the volumes of each base formula needed for a formula blend having the targeted caloric density, volumes, and nutrition profile.

It has also been found that the above method most readily adapts to a wider range of nutritional needs if the plurality of base infant formulas includes a hypercaloric isotonic infant formula. It has also been discovered that such a formula can be formulated, provided that it contains selected protein, fat, and carbohydrate concentrations, and provided that the fat component includes from about 10% to about 90% by weight of a medium chain triglyceride oil.

### SUMMARY OF THE INVENTION

A first embodiment of the present invention is therefore directed to a method of tailoring infant formulas to individual nutrition needs prior to use, said method comprising the steps of (A) determining the desired volume and optimal caloric density of a formula to be fed to a preterm or low birth weight infant; (B) obtaining a plurality of base infant formulas, all in liquid form, comprising fat, protein, carbohydrate, vitamins, and minerals, each of which has an osmolality of from about 200 to about 360 mOsm/kg water and a different caloric density within a range of from about 609 to about 1082 kcal/L; (C) selecting two of the base liquid formulas having a caloric density value above and below the optimal caloric density, (D) calculating the volume of each selected base formula needed to produce the desired volume of an infant formula blend having the optimal caloric density; (E) combining the calculated volumes of the selected base formulas to produce an infant formula blend having the desired volume, optimal caloric density, osmolality of between 200 and 360 mOsm/kg water, and caloric density of between 609 and 1082 kcal/L, and then (F) feeding the resulting formula to the preterm or low birth weight infant.

A second embodiment of the present invention is directed to an infant formula kit comprising 1) a plurality of base infant formulas comprising fat, protein, carbohydrate, vitamins, and minerals, each of which has an osmolality of from about 200 to about 360 mOsm/kg water and a different caloric density within a range of from about 609 kcal/L (18 kcal/fl. oz) to about 1082 kcal/L (32 kcal/fl. oz.) and; 2) a device for calculating the volumes of each base formula needed for a formula blend having a target caloric density.

A third embodiment of the present invention is directed to a hypercaloric isotonic infant formula, particularly useful in the methods and infant formula kits hereof, comprising from about 25 to about 40 g/L of protein, from about 56 to about 90 g/L of fat, and at least about 40 g/L of carbohydrate, wherein the formula has a caloric density of from about 981 kcal/L (29 kcal/L) to about 1082 kcal/L (32 kcal/L), an osmolality of from about 280 to about 360 mOsm/kg water, and a fat component of which from about 10% to about 90% is a medium chain triglyceride oil.

The above method, compositions, and infant formula kits are especially useful in preterm, low birth weight, or other infants who are hospitalized and have fluctuating nutritional or fluid restriction needs during the first several months of life. The method and kit, especially when used with the hypercaloric isotonic infant formula embodiment, provides a simple means for quickly preparing individualized infant formulas prior to use, with reduced risk of formulation error and contamination, and reduced personnel time in formula calculation, modification, and preparation.

And since each of the base infant formulas contains sufficient nutrients to be used as a sole source of nutrition, the resulting blend of formulas may likewise be used as a sole source of nutrition, without the need for recalculating and adding specific nutrients to provide sole source nutrition.

### DETAILED DESCRIPTION OF THE INVENTION

The methods, compositions, and infant formula kits of the present invention are described in detail hereinafter.

The term “base infant formula” as used herein, unless otherwise specified, means a ready-to-feed infant formula having sufficient nutrients to provide sole source nutrition for appropriate preterm or low birth weight infants.

The term “isotonic” as used herein, unless otherwise specified, defines an infant formula having an osmolality of from about 200 to about 360 mOsm/kg water, preferably from about 235 to about 350 mOsm/kg water.

The term “infant” as used herein refers to individuals not more than about one year of age, and includes infants from 0 to about 4 months of age, infants from about 4 to about 8 months of age, infants from about 8 to about 12 months of age, low birth weight infants at less than 2,500 grams at birth, and preterm infants born at less than about 37 weeks gestational age, typically from about 26 weeks to about 34 weeks gestational age.

The term “ready-to-feed” as used herein, unless otherwise specified, refers to infant formulas in liquid form suitable for administration to an infant. As described herein, all infant formula embodiments of the present invention, all base infant formulas, and all blended formulas from the base infant formulas, are ready-to-feed liquids.

All percentages, parts and ratios as used herein are by weight of the total composition, unless otherwise specified. All such weights as they pertain to listed ingredients are based on the active level and, therefore, do not include solvents or by-products that may be included in commercially available materials, unless otherwise specified.

All references to singular characteristics or limitations of the present invention shall include the corresponding plural characteristic or limitation, and vice versa, unless otherwise specified or clearly implied to the contrary by the context in which the reference is made.

All combinations of method or process steps as used herein can be performed in any order, unless otherwise specified or clearly implied to the contrary by the context in which the referenced combination is made.

The methods, feeding kits, and infant formulas of the present invention may also be substantially free of any optional or selected ingredient or feature described herein, provided that the remaining embodiment still contains all of the required ingredients or features as described herein. As applied to infant formulas, the term “substantially free” means that the selected composition contains less than a functional amount of the optional ingredient, typically less than 0.1% by weight, and also including zero percent by weight of such optional or selected essential ingredient.

The methods and compositions of the present invention, including components thereof, can comprise, consist of, or consist essentially of the essential elements and limitations of the invention described herein, as well as any additional or optional ingredients, components, or limitations described herein or otherwise useful in nutritional formula applications.

Method

The first embodiment of the present invention is a method of tailoring the caloric density, feeding volume, and nutrition profile of an infant formula to the particular medical and nutritional needs of an individual preterm or low birth weight infant, prior to use. The method comprises the steps of:
1) determining the desired volume and optimal caloric density of a formula to be fed to a particular preterm or low birth weight infant;
2) obtaining a plurality of base liquid formulas comprising fat, protein, carbohydrate, vitamins, and minerals, each of which has an osmolality of from about 200 to about 360 mOsm/kg water and a different caloric density within a range of from about 609 to about 1082 kcal/L;
3) selecting two of the base liquid formulas having caloric density values above and below the optimal caloric density,
4) calculating the volume of each selected base formula needed to produce the desired volume of an infant formula blend having the optimal caloric density; and
5) combining the calculated volumes of the selected base formulas to produce an infant formula blend having the desired volume, optimal caloric density, an osmolality between 200 and 360 mOsm/kg water, and a caloric density between 609 and 1082 kcal/L; and then
6) feeding the resulting formula to the preterm or low birth weight infant.

In the first step of the method, the determination of optimal caloric density and feeding volume is established by the infant's physician, dietitian, or other qualified individual skilled in prescribing or recommending nutrition for an infant in view of current medical and nutritional needs. One skilled in infant nutrition can readily make such a determination.

In the second step of the method, a plurality of base infant formulas is obtained, each of which has sufficient nutrients to provide a sole source of nutritional. The plurality comprises at least 2, preferably from 3 to 6, base formulas. Most preferably, the plurality of base formulas includes at least three such formulas—a first base formula having a caloric density of from about 609 kcal/L (18 kcal/fl. oz) to about 743 kcal/L (22 kcal/fl. oz), a second base formula having a caloric density of from about 778 kcal/L (23 kcal/fl. oz) to about 947 kcal/L (28 kcal/fl. oz.) and a third base formula having a caloric density of from about 981 kcal/L (29 kcal/fl. oz.) to about 1082 kcal/L (32 kcal/fl. oz).

In the third step of the method, two base formulas are selected from the plurality of base formulas so that their respective caloric densities define a range within which the optimal caloric density of the desired formula lies. For example, if the optimal caloric density is 812 kcal/L (24 kcal/fl. oz), then one formula would be selected having a higher caloric density (e.g., 1082 kcal/L or 32 kcal/fl. oz.) and a second formula would be selected having a lower caloric density (e.g., 676 kcal/L or 20 kcal/fl. oz.).

In the fourth step of the process, the volume of each of the two selected base formulas needed to form a formula blend having the optimal caloric density is calculated using the formula (blend equations):
V₁=[V_{f}×(D₂−D_{f})]÷(D₂−D₁)
V₂=V_{f}−V₁
wherein

V_{f}=final blend volume (liters)

D_{f}=final blend caloric density (kcal/L)

V₁=volume of the least calorically dense base selected (liters)

V₂=volume of the most calorically dense base selected (liters)

D₁=caloric density of least calorically dense base selected (kcal/L)

D₂=caloric density of most calorically dense base selected (kcal/L)

and wherein the volume of each selected base formula is selected from within 5%, preferably within 3%, more preferably within a range of from 0 to 1%, of the calculated values for V1 and V2.

For example:

Target blend formula: 0.1 L (D_{f}) at 947 kcal/L (V_{f})

1^{st} base infant formula: 812 kcal/L (D₁)

2^{nd} base infant formula: 1082 kcal/L (D₂)

V₁=[V_{f}×(D₂−D_{f})]÷(D₂−D₁)

V₁=[0.1 L×(1082 kcal/L−947 kcal/L)]÷(1082 kcal/L−812 kcal/L)

V₁=[0.1 L×(135 kcal/L)]÷(270 kcal/L)

V₁=0.05 L (±0-5%)

V₂=V_{f}−V₁

V₂=0.1 L−0.05 L

V₂=0.05 L (±0-5%)

In the fifth step of the method, the calculated volumes of the selected base formulas are combined to form a formula blend having the desired volume, optimal caloric density, osmolality of from about 200 to about 360 mOsm/kg water, and caloric density of between 609 and 1082 kcal/L.

In the final step of the method, the formula blend is then fed to a preterm or low birth weight infant. It should be emphasized that each base infant formula used in the method, and the resulting infant formula blend, must be isotonic and have sufficient nutrients to provide a sole source of nutrition.

The method may further comprise the addition of other nutrients prior to, during, or after the blending steps, but it is preferred that only the base infant formulas are mixed together to form the final blend. To the extent that other nutrients are added, it is highly preferred that such other nutrients are added in liquid rather than powder form prior to, during, or after the blending steps. The method is therefore preferably free of any powder addition steps.

The method may further comprise the addition of nutrition liquids such as human milk, human milk fortifier liquid, and human milk concentrates, provided that the resulting blend is isotonic and can provide a sole source of nutrition. Especially useful are the addition of human milk fortifier liquids such as those described in U.S. patent application Ser. No. 11/370,610, filed Mar. 8, 2006.

Base Formulas

The base formulas for use in the method, in addition to being isotonic, must also have different caloric density values ranging from about 609 kcal/liter to about 1082 kcal/liter. The broader the range, the broader the range of possible caloric densities made possible by the blends. Representative base formulas, as defined by caloric densities, include those having any of the caloric density values described below, or combinations thereof.

Base Infant Formulas - Caloric Density Range

| kcal/fl. oz. | kcal/liter | Kcal/fl. oz. | kcal/liter |
|---|---|---|---|
| 18 | 609 | 26 | 879 |
| 19 | 643 | 27 | 913 |
| 20 | 676 | 28 | 947 |
| 21 | 710 | 29 | 981 |
| 22 | 743 | 30 | 1015 |
| 23 | 778 | 31 | 1048 |
| 24 | 812 | 32 | 1082 |
| 25 | 845 | | |

*kcal/L = kcal/fl. oz × 33.82

The base infant formulas comprise fat, protein, carbohydrate, vitamins and minerals, all of which are selected in kind and amount to provide a sole source of nutrition for the targeted infant or defined infant population. Infant formulas for use as base formulas include any known ready-to-feed infant formula, or any nutritional formula suitable for use in infants, provided that such a formula is a sole source nutritional having caloric density and osmolality values within the ranges defined herein.

Many different sources and types of carbohydrates, fats, proteins, minerals and vitamins are known and can be used in the base formulas herein, provided that such nutrients are compatible with the added ingredients in the selected formulation and are otherwise suitable for use in an infant formula.

Carbohydrates suitable for use in the base formulas herein may be simple or complex, lactose-containing or lactose-free, or combinations thereof, non-limiting examples of which include hydrolyzed, intact, naturally and/or chemically modified cornstarch, maltodextrin, glucose polymers, sucrose, corn syrup, corn syrup solids, rice or potato derived carbohydrate, glucose, fructose, lactose, high fructose corn syrup and indigestible oligosaccharides such as fructooligosaccharides (FOS), galactooligosaccharides (GOS), and combinations thereof.

Proteins suitable for use in the base formulas herein include hydrolyzed, partially hydrolyzed, and non-hydrolyzed or intact proteins or protein sources, and can be derived from any known or otherwise suitable source such as milk (e.g., casein, whey, human milk protein), animal (e.g., meat, fish), cereal (e.g., rice, corn), vegetable (e.g., soy), or combinations thereof.

Proteins for use herein can also include, or be entirely or partially replaced by, free amino acids known for or otherwise suitable for use in infant formulas, non-limiting examples of which include alanine, arginine, asparagine, carnitine, aspartic acid, cystine, glutamic acid, glutamine, glycine, histidine, isoleucine, leucine, lysine, methionine, phenylalanine, proline, serine, taurine, threonine, tryptophan, taurine, tyrosine, valine, and combinations thereof. These amino acids are most typically used in their L-forms, although the corresponding D-isomers may also be used when nutritionally equivalent. Racemic or isomeric mixtures may also be used.

Fats suitable for use in the base formulas herein include coconut oil, soy oil, corn oil, olive oil, safflower oil, high oleic safflower oil, algal oil, MCT oil (medium chain triglycerides), sunflower oil, high oleic sunflower oil, palm and palm kernel oils, palm olein, canola oil, marine oils, cottonseed oils, and combinations thereof.

Vitamins and similar other ingredients suitable for use in the base formulas include vitamin A, vitamin D, vitamin E, vitamin K, thiamine, riboflavin, pyridoxine, vitamin B12, niacin, folic acid, pantothenic acid, biotin, vitamin C, choline, inositol, salts and derivatives thereof, and combinations thereof.

Minerals suitable for use in the base formulas include calcium, phosphorus, magnesium, iron, zinc, manganese, copper, chromium, iodine, sodium, potassium, chloride, and combinations thereof.

The base formulas and formula blends may also comprise nutrients in accordance with the relevant infant formula guidelines for the targeted user population, an example of which includes guidelines for preterm infants by the Life Sciences Research Office (LSRO), its staff and its advisors, and the Expert Panel in the publication, “Nutrient Requirements for Preterm Infant Formula”, Klein, C. J. (2002), Journal of Nutrition 132: 1395S-1577S.

Fat, carbohydrate, and protein concentrations in the base infant formulas and formula blends include those macronutrient ranges described in the following table.

Infant Formula Nutrients¹

| | | Gram per | Gram per |
|---|---|---|---|
| Nutrient | Range | 100 kcal | liter |
| Carbohydrate | 1^{st} embodiment | 6-16 | 37-173 |
| | 2^{nd} embodiment | 7-13 | 42-140 |
| Fat | 1^{st} embodiment | 3-8 | 18-87 |
| | 2^{nd} embodiment | 4-6.6 | 24-71 |
| Protein | 1^{st} embodiment | 1-3.5 | 6-42 |
| | 2^{nd} embodiment | 1.5-3.4 | 9-37 |

¹Numerical values may be modified by the term “about”

The base infant formulas and formula blends, as potential sole sources of nutrition for preterm and low birth weight infants, also typically comprise per each 100 kcal of formula, from about 120 to about 190 mg of calcium, sufficient phosphorous to provide a calcium to phosphorous mass ratio of from about 1.7:1 to about 2:1, from about 1 to about 2 mg of zinc, from about 100 to about 250 mcg of copper, and from about 30 to about 70 mg of sodium.

The base infant formulas and formula blends more typically comprise, per each 100 kcal of formula, each of the following: from about 120 to about 190 mg of calcium, phosphorous in a calcium to phosphorous mass ratio of from about 1.7:1 to about 2:1, from about 6 to about 17 mg of magnesium, from about 0.3 to about 4 mg of iron, from about 1 to about 2 mg of zinc, from about 6 to about 30 mcg of manganese, from about 100 to about 300 mcg of copper, from about 5 to bout 40 mcg of iodine, from about 35 to about 70 mg of sodium, from about 50 to about 200 mg of potassium, from about 50 to about 200 mg of chloride, from about 1 to about 6 mcg of selenium, from about 5 to about 30 mcg of fluoride, from about 200 to about 500 mcg of vitamin A, from about 50 to about 500 IU of vitamin D, from about 2 to about 30 mcg of vitamin K, from about 20 to about 400 mcg of thiamin, from about 50 to about 700 mcg of riboflavin, from about 400 to about 7000 mcg of niacin, from about 20 to about 300 mcg of pyridoxine, from about 0.05 to about 1.0 mcg of vitamin B12, from about 20 to about 50 mcg of folic acid, from about 200 to about 3000 mcg of pantothenic acid, from about 1 to about 50 mcg of biotin, and from about 5 to about 50 mg of vitamin C.

The base infant formulas and formula blends may further comprise other optional ingredients that may modify the physical, chemical, aesthetic or processing characteristics of the compositions or serve as pharmaceutical or additional nutritional components when used in the targeted infant or infant population. Many such optional ingredients are known or are otherwise suitable for use in nutritional products and may also be used in the infant formulas of the present invention, provided that such optional materials are compatible with the essential materials described herein and are otherwise suitable for use in a preterm or low birth weight infant formula.

Non-limiting examples of such optional ingredients include additional anti-oxidants, emulsifying agents, buffers, colorants, flavors, nucleotides and nucleosides, probiotics, prebiotics, lactoferrin and related derivatives, thickening agents and stabilizers, and so forth.

The base infant formulas may be individually packaged and sealed in single or multi-use containers, and then stored under ambient conditions for up to about 36 months or longer, more typically from about 12 to about 24 months.

Infant Formula Kits

The methods of the present invention are preferably directed to infant formula feeding kits. The kits comprise a plurality of the base infant formulas as described herein. The kits preferably include from 3 to 6 base infant formulas, each of which contains fat, protein, carbohydrate, vitamins and minerals, is a potential sole source of nutrition, and has an osmolality of from 200 to about 360 mOsm/kg water, wherein each base formula has a different caloric density within a range of from about 609 to about 1082 kcal/L, and wherein all base formulas are safe and effective for blending together prior to administration to a preterm or low birth weight infant.

The infant formula kits further comprise a device for calculating base formula proportions in accordance with the method of the present invention. Device calculations are preferably based upon the blend equations described hereinbefore. Suitable devices include electronic and non-electronic devices, manual and programmed devices, nomograms, and charts, graphs or tables with precalculated blend volumes. Non limiting examples of such devices include programmed calculators, software programs for use with a computer, two-dimensional graphs or charts or tables, or other tangible items designed to calculate base formula proportions, or provide precalculated base formula proportions, to achieve an infant formula blend with a targeted caloric density, volume, and nutrition profile. Charts, graphs, and tables with precalculated blend volumes are the preferred device for use herein.

An example of a device for use in the method and kits of the present invention include the following formulation chart based upon the blend equations described herein.

Formulation Chart - Based on 20, 24,
and 30 kcal Base Infant Formulas

| Targeted Infant Formula Blend¹ | Preblend volumes² |
|---|---|
| 743 kcal/L (22 kcal/fl. oz.) | 1 part 20 kcal/fl. oz. (676 kcal/L) |
| | 1 part 24 kcal/fl oz. (812 kcal/L) |
| 879 kcal/L (26 kcal/fl. oz.) | 2 parts 24 kcal/fl oz. (812 kcal/L) |
| | 1 part 30 kcal/fl oz. (1015 kcal/L) |
| 913 kcal/L (27 kcal/fl. oz.) | 1 part 24 kcal/fl oz. (812 kcal/L) |
| | 1 part 30 kcal/fl oz. (1015 kcal/L) |
| 947 kcal/L (28 kcal/fl. oz.) | 1 part 24 kcal/fl. oz. (812 kcal/L) |
| | 2 parts 30 kcal/fl oz. (1015 kcal/L) |

¹Actual blend is ±5% by volume of targeted infant formula blend
²Infant formulas should be measured by volume when mixing as fill weights can vary

Software programs suitable for use herein include Ross Neonova Nutrition Optimizer, available from Ross Products Division, Abbott Laboratories, Columbus, Ohio, USA.

Hypercaloric Isotonic Infant Formula

Another embodiment of the present invention is a hypercaloric isotonic infant formula suitable for use in preterm or low birth weight infants, especially those in need of fluid restricted diets or of increased caloric consumption. These hypercaloric isotonic infant formulas are especially useful in accordance with the methods of the present invention as a hypercaloric base infant formula.

The hypercaloric isotonic infant formula of the present invention comprises fat, protein, carbohydrate, carbohydrate, vitamins, and minerals, and has an osmolality and caloric density, all as described in the table below:

Hypercaloric Isotonic Infant formula¹

| Nutrient | Embodiment A | Embodiment B |
|---|---|---|
| | gm/L | |
| Carbohydrate | ≧40 | 50-85 |
| Fat² | 56-90 | 60-75 |
| Protein | 25-40 | 29-35 |
| | mOsm/kg water | |
| Osmolality | 280-360 | 300-350 |
| | Kcal/L | |
| Caloric density | 981-1082 | 1000-1050 |

¹All numeral terms preceded by the term “about”
²Includes medium chain triglyceride oil

The hypercaloric formula embodiment of the present invention is an isotonic liquid that comprises protein, fat, carbohydrates, vitamins, and minerals suitable for use in an infant formula, including those described herein for use in the base infant formulas for use in the method of the present invention.

The hypercaloric isotonic formula, to achieve the desired caloric density, osmolality, and nutrition profile, comprises a medium chain triglyceride (MCT) as part of the total fat component, wherein the medium chain triglyceride represents from about 10% to about 90%, including from about 25% to about 75%, and also including from about 35% to about 65%, by weight of total fat in the formula.

Any medium chain triglyceride suitable for use in infant formulas may be used in the hypercaloric isotonic infant formula of the present invention. Medium chain triglycerides are triacylglyerol esters of C6-14 fatty acids, more typically C6-12 fatty acids, including C8-10 fatty acids. Refined coconut oil is a common source of medium chain triglycerides suitable for use in infant formulas.

It has been found that a hypercaloric infant formula can be prepared as an isotonic ready-to-feed formula, provided that the fat, protein, and carbohydrate concentrations are selected from within the above ranges. The fat component must also contain the requisite amount of medium chain triglyceride oil to achieve the desired nutrition profile for the hypercaloric formula.

Method of Manufacture

The base infant formulas of the present invention may be prepared by any known or otherwise effective technique suitable for making and formulating a ready-to-feed liquid infant formula or similar other composition. Such techniques and variations thereof for any given formula are easily determined and applied by one of ordinary skill in the infant nutrition formulation or manufacturing arts in the preparation of the formulas described herein.

Manufacturing systems for a ready-to-feed liquid formula typically include formation of a slurry from one or more solutions which may contain water and one or more of the following: carbohydrates, proteins, lipids, stabilizers, vitamins and minerals. This slurry is emulsified, homogenized and cooled. Various other solutions may be added to the slurry before processing, after processing or at both times. The processed formula is then sterilized, with an appropriate amount of water added prior to and following sterilization, to form a ready-to-feed liquid.

Other suitable methods for making nutritional formulas are described, for example, in U.S. Patent Application 20030118703 A1 (Nguyen, et al.), which description is incorporated herein by reference.

### EXAMPLES

The following examples represent specific embodiments within the scope of the present invention, each of which is given solely for the purpose of illustration and is not to be construed as limitations of the present invention, as many variations thereof are possible without departing from the spirit and scope of the invention. All exemplified amounts are weight percentages based upon the total weight of the composition, unless otherwise specified.

The following are base infant formulas, including a hypercaloric isotonic embodiment (Formula 1) of the present invention, suitable for use in the method and infant formula feeding kits of the present invention. All are emulsified liquids. Ingredients for each formula are listed in the table below.

Base Liquid Formulas

| | Base Formula | Base Formula | Base Formula |
|---|---|---|---|
| | 1 | 2 | 3 |
| | 1014 kcal/L | 812 kcal/L | 676 kcal/L |
| | (30 kcal/ | (24 kcal/ | (20 kcal/ |
| | fl. oz.) | fl. oz) | fl. oz) |
| | Amt per 45359 | per 45359 kg | per 45359 kg |
| Ingredients | kg (100000 lbs) | (100000 lbs) | (100000 lbs) |
| Water (kg) | 37194 | 38360 | 39482 |
| NonFat Milk (kg) | 8376 | 5250 | 4422 |
| Corn | 1606 | 1712 | 1425 |
| Maltodextrin (kg) | | | |
| Medium Chain | 1434 | 935 | 786 |
| Triglyceride | | | |
| Oil (kg) | | | |
| Soy Oil (kg) | 860 | 561 | 471 |
| Whey Protein | 640 | 683 | 575 |
| Concentrate (kg) | | | |
| Coconut Oil (kg) | 524 | 342 | 287 |
| Lactose (kg) | 431 | 846 | 695 |
| Calcium | 119 | 108 | 109 |
| Phosphate (kg) | | | |
| Ascorbic | 51.8 | 41.4 | 39.5 |
| Acid (kg) | | | |
| Calcium | 38.8 | 22.2 | 11.4 |
| Carbonate (kg) | | | |
| Lecithin (kg) | 29.9 | 19.6 | 16.5 |
| Monoglycerides | 29.9 | 19.6 | 16.5 |
| (kg) | | | |
| Magnesium | 25.1 | 19.5 | 18.3 |
| Chloride (kg) | | | |
| Sodium | 24.0 | 14.9 | 11.4 |
| Citrate (kg) | | | |
| m-Inositol (kg) | 20.9 | 16.7 | 13.8 |
| Carrageenan (kg) | 5.4 | 13.6 | 13.6 |
| Ferrous | 3.90 | 3.12 | 2.62 |
| Sulfate (kg) | | | |
| Choline | 2.73 | 2.18 | 1.61 |
| Chloride (kg) | | | |
| L-Carnitine (kg) | 2.10 | 1.66 | 1.39 |
| Water Soluble | 15.4 | 12.3 | 10.3 |
| Vitamin | | | |
| Premix (kg) | | | |
| Nucleotide | 16.6 | 13.3 | 13.3 |
| Choline | | | |
| Premix (kg) | | | |
| Oil Soluble | 5.61 | 4.49 | 3.75 |
| Vitamin | | | |
| Premix (kg) | | | |
| ARA Oil (kg) | 24.5 | 19.6 | 16.5 |
| DHA Oil (kg) | 15.4 | 12.3 | 10.4 |
| Vitamin A | 454 | 363 | 310 |
| Palmitate (g) | | | |
| Potassium | 0.209 | 24.1 | 15.3 |
| Citrate (kg) | | | |
| Beta- | 28.5 | 22.8 | 19.0 |
| Carotene (g) | | | |
| Osmolality | 325 | 280 | 235 |
| (mOsm/kg water) | | | |

Each of the exemplified base formulas may be prepared in a similar manner by making at least two separate slurries that are later blended together, heat treated, standardized, packaged and sterilized. Initially, hydrolyzed corn starch-mineral slurry is prepared by dissolving hydrolyzed cornstarch in water at 54-71° C., followed by the addition of magnesium chloride, choline chloride, and sodium citrate. The resulting slurry is held under moderate agitation at 54-63° C. for no longer than twelve hours until it is later blended with the other prepared slurries.

An oil slurry is prepared by combining soybean oil, coconut oil at 55-60° C., medium chain triglyceride oil, followed by the addition of vitamin ADEK premix, mono-and diglycerides, lecithin, carrageenan, vitamin A, ARA oil, and DHA oil. The resulting oil slurry is held under moderate agitation at 49-66° C. for no longer than six hours until it is later blended with the other prepared slurries.

A protein-lactose slurry is prepared by dissolving lactose, whey protein, and non-fat dry milk in water at 52-60° C., followed by the addition of calcium carbonate and calcium phosphate. The resulting protein-lactose slurry is held under moderate agitation at 52-60° C. for no longer than two hours until it is later blended with the other prepared slurries.

The hydrolyzed corn starch-mineral slurry is then combined with the protein-lactose slurry. The oil slurry is then added and the resulting mixture agitated for at least 10 minutes. The pH of the resulting blend is adjusted to 6.45-7.10 with 5 wt % potassium hydroxide. The resulting blend is held under moderate agitation at 52-60° C.

After waiting for a period of not less than one minute nor greater than two hours, the resulting blend is heated to 71-82° C., emulsified through a single stage homogenizer at 100-300 psig, and then heated to 144-147° C., for about 5 seconds. The heated blend is passed through a flash cooler to reduce the temperature to 82-93° C. and then through a plate cooler to further reduce the temperature to 77-82° C. The cooled blend is then homogenized at 3900-4100/400-600 psig, and then held at 79-91° C. for 16 seconds, and then cooled to 1-7° C. Samples are taken for microbiological and analytical testing. The mixture is held under agitation.

A water-soluble vitamin (WSV) solution and an ascorbic acid solution are prepared separately and added to the processed blended slurry. The vitamin solution is prepared by adding the following ingredients to water with agitation: potassium citrate, ferrous sulfate, WSV premix, L-carnitine, M-inositol, and the nucleotide-choline premix. The ascorbic acid solution is prepared by adding 5 wt % potassium hydroxide and ascorbic acid to a sufficient amount of water to dissolve the ingredients. The ascorbic acid solution pH is then adjusted to 7-10 with 5 wt % potassium hydroxide solution.

Based on the analytical results of the quality control tests, an appropriate amount of water is added to the batch with agitation to achieve the desired total solids. The product pH may be adjusted to achieve optimal product stability. The completed product is then placed in suitable containers and subjected to terminal sterilization.

The approximate nutrient profiles for each of the base formulas 1-3 are described in the following table:

| | | Formula 1 | Formula 2 | Formula 3 |
|---|---|---|---|---|
| | | 1014 kcal/L | 812 kcal/L | 676 kcal/L |
| | | (30 kcal/ | (24 kcal/ | (20 kcal/ |
| Nutrients | | fl. oz.) | fl. oz) | fl. oz) |
| Energy | kcal | 101 | 81 | 68 |
| Volume | mL | 100 | 100 | 100 |
| Protein | g | 3.04 | 2.43 | 2.03 |
| Fat | g | 6.71 | 4.41 | 3.67 |
| Carbohydrate | g | 7.8 | 8.4 | 7.0 |
| Calcium | mg | 183 | 146 | 122 |
| Phosphorus | mg | 101 | 81 | 68 |
| Magnesium | mg | 12.2 | 9.7 | 8.1 |
| Iron | mg | 1.83 | 1.46 | 1.22 |
| Zinc | mg | 1.52 | 1.22 | 1.01 |
| Manganese | mcg | 12 | 10 | 8 |
| Copper | mcg | 254 | 203 | 169 |
| Iodine | mcg | 6 | 5 | 4 |
| Sodium | meq | 1.9 | 1.5 | 1.3 |
| Potassium | meq | 3.4 | 2.7 | 2.2 |
| Chloride | meq | 2.3 | 1.9 | 1.6 |
| Vitamin A | IU | 1268 | 1014 | 845 |
| Vitamin D | IU | 152 | 122 | 101 |
| Vitamin E | IU | 4.1 | 3.2 | 2.7 |
| Vitamin K | mcg | 12.2 | 9.7 | 8.1 |
| Thiamin | mcg | 254 | 203 | 169 |
| Riboflavin | mcg | 629 | 503 | 419 |
| Vitamin B6 | mcg | 254 | 203 | 169 |
| Vitamin B12 | mcg | 0.56 | 0.45 | 0.37 |
| Niacin | mcg | 5072 | 4058 | 3381 |
| Folic acid | mcg | 37.5 | 30.0 | 25.0 |
| Pantothenic | mcg | 1927 | 1542 | 1285 |
| acid | | | | |
| Biotin | mcg | 37.5 | 30.0 | 25.0 |
| Vitamin C | mg | 38 | 30 | 25 |
| Choline | mg | 10 | 8 | 7 |
| Inositol | mg | 41 | 32 | 27 |

### Examples

### Methods

An infant feeding kit is prepared comprising base formulas 1, 2 and 3 and a programmed calculator designed to calculate blend volumes to achieve an optimal caloric density and feeding volume for a specific infant. The calculator is programmed with the blend equations described herein.

A second infant feeding kit is prepared comprising base formulas 1, 2 and 3 and a nomogram based on the blend equations to calculate blend volumes to achieve an optimal caloric density and feeding volume for a specific infant. The rotating wheel chart is based upon the blend equations described herein.

A third infant feeding kit is prepared comprising base formulas 1, 2 and 3 and a calculating device in the form of a chart comprising precalculated blend volumes to achieve an optimal caloric density and feeding volume for a specific infant. The chart is based upon the blend equations described herein.

Case 1: A physician determines that a preterm infant at 27 weeks gestation requires 0.100 L of a 900 kcal/L isotonic formula, daily for 24 hours, especially in view of current fluid restrictions. To prepare the formulae, Base Formulas 1 (1015 kcal/L) and 2 (812 kcal/L) are selected from an infant feeding kit and blended together in volumes within 10% of the values calculated below:

V₁=[V_{f}×(D₂−D_{f})]÷(D₂−D₁)

V₁=[0.1 L×(1015 kcal/L−900 kcal/L)]÷(1015 kcal/L−812 kcal/L)

V₁=[0.1 L×(115 kcal/L)]÷(203 kcal/L)

V₁=0.057 L (±1%)

V₂=V_{f}−V₁

V₂=0.1 L−0.057 L

V₂=0.043 L (±1%)

The resulting blend is isotonic, provides 900 kcal/L, and is fed to the infant within 4 hours of reformulation as a potential sole source of nutrition.

Case 2: A dietitian determines that a preterm infant at 31 weeks gestation requires 0.110 L of a 760 kcal/L isotonic formula, daily for 3 days. To prepare the formulae, Base Formulas 2 (812 kcal/L) and 3 (676 kcal/L) are selected and blended together in volumes within 10% of the values calculated below:

V₁=[V_{f}×(D₂−D_{f})]÷(D₂−D₁)

V₁=[0.110 L×(812 kcal/L−760 kcal/L)]÷(812 kcal/L−676 kcal/L)

V₁=[0.110 L×(115 kcal/L)]÷(203 kcal/L)

V₁=0.062 L (±1%)

V₂=V_{f}−V₁

V₂=0.1 L−0.062 L

V₂=0.038 L (±1%)

The resulting blend is isotonic, provides 760 kcal/L, and is fed to the infant within 2 hours of reformulation as a potential sole source of nutrition.

Case 3: A dietitian determines that a low birth weight infant requires varied volumes of a 947 kcal/L formula until discharge. It is then determined from a published chart of formula blend volumes (derived from blend equations) to mix 2 parts volume of Formula 1 and 1 part by volume of Formula 2. The resulting blend is isotonic, provides 947 kcal/L, and is fed to the infant immediately following reformulation. The blend is a potential sole source of nutrition.

Case 4: A physician determines that a low birth weight infant requires 0.100 L of an isotonic infant formula (1015 kcal/L) daily for 3 days. Base infant formula 1 is then fed to the infant as prescribed, as a potential sole source of nutrition without blending or combing with other base formulas.

What is claimed is:

1. A method of controlling the caloric density of an infant formula prior to use, said method comprising:
A) determining the desired volume and optimal caloric density of a formula to be fed to a particular preterm or low birth weight infant;
B) obtaining a plurality of base liquid formulas comprising fat, protein, carbohydrate, vitamins, and minerals, each of which has an osmolality of from about 200 to about 360 mOsm/kg water and a different caloric density within a range of from about 609 to about 1082 kcal/L;
C) selecting two of the base liquid formulas having a caloric density values above and below the optimal caloric density,
D) calculating the volume of each selected base formula needed to produce the desired volume of an infant formula blend having the optimal caloric density;
E) combining the calculated volumes of the selected base formulas to produce an infant formula blend having the desired volume, optimal caloric density, an osmolality between 200 and 360 mOsm/kg water, and a caloric density between 609 and 1082 kcal/L;
F) feeding the resulting formula to the preterm or low birth weight infant.

2. The method of claim 1 wherein the volume of each selected base formula is calculated using the blend equations:
V₁=[V_{f}×(D₂−D_{f})]÷(D₂−D₁)
V₂=V_{f}−V₁
wherein
V_{f}=final blend volume (liters)
D_{f}=final blend caloric density (kcal/L)
V₁=volume of the least calorically dense base selected (liters)
D₁=caloric density of least calorically dense base selected (kcal/L)
V₂=volume of the most calorically dense base selected (liters)
D₂=caloric density of most calorically dense base selected (kcal/L)
and wherein the volume of each selected base formula is selected from within 5% of the calculated values for V₁ and V₂.

3. The method of claim 2 wherein each of the base infant formulas contains sufficient nutrients to provide a sole source of nutrition to a preterm or low birth weight infant.

4. The method of claim 3 wherein each of the base infant formulas comprises, per 100 kcal of formula,
(A) from about 120 to about 190 mg of calcium,
(B) phosphorous in a calcium to phosphorous mass ratio of from about 1.7:1 to about 2:1,
(C) from about 1 to about 2 mg of zinc,
(D) from about 100 to about 250 mcg of copper, and
(E) from about 30 to about 70 mg of sodium.

5. The method of claim 4 wherein each of the base infant formulas further comprises, per 100 kcal of formula: from about 120 to about 190 mg of calcium, phosphorous in a calcium to phosphorous mass ratio of from about 1.7:1 to about 2:1, from about 6 to about 17 mg of magnesium, from about 0.3 to about 4 mg of iron, from about 1 to about 2 mg of zinc, from about 6 to about 30 mcg of manganese, from about 100 to about 300 mcg of copper, from about 5 to bout 40 mcg of iodine, from about 35 to about 70 mg of sodium, from about 50 to about 200 mg of potassium, from about 50 to about 200 mg of chloride, from about 1 to about 6 mcg of selenium, from about 5 to about 30 mcg of fluoride, from about 200 to about 500 mcg of vitamin A, from about 50 to about 500 IU of vitamin D, from about 2 to about 30 mcg of vitamin K, from about 20 to about 400 mcg of thiamin, from about 50 to about 700 mcg of riboflavin, from about 400 to about 7000 mcg of niacin, from about 20 to about 300 mcg of pyridoxine, from about 0.05 to about 1.0 mcg of vitamin B12, from about 20 to about 50 mcg of folic acid, from about 200 to about 3000 mcg of pantothenic acid, from about 1 to about 50 mcg of biotin, and from about 5 to about 50 mg of vitamin C.

6. A method according to claim 2 wherein the plurality of base infant formulas includes a first base formula having a caloric density of from about 609 kcal/L to about 743 kcal/L, a second base formula having a caloric density of from about 778 to about 947 kcal/L, and a third base formula having a caloric density of from about 981 kcal/L to about 1082 kcal/L.

7. A method according to claim 2 wherein the plurality of base infant formulas includes a first base formula having a caloric density of from about 620 to about 660 kcal/L, a second base formula having a caloric density of from about 790 to about 830 kcal/L, and a third base formula having a caloric density of from about 995 to about 1035 kcal/L.

8. A method according to claim 1 wherein the resulting formula can be used as a sole source of nutrition.

9. An infant formula feeding kit comprising:
(A) a plurality of packaged base formulas, each of which contains fat, protein, carbohydrate, and has an osmolality of from 200 to about 360 mOsm/kg water, wherein each base formula has a different caloric density within a range of from about 609 kcal/L to about 1082 kcal/L, and
(B) a device for calculating the volumes of any two base formulas needed to produce a blend of the two formulas having a specific volume and caloric density.

10. An infant feeding kit according to claim 9, wherein the plurality of base infant formulas includes a first base formula having a caloric density of from about 609 kcal/L to about 743 kcal/L, a second base formula having a caloric density of from about 778 to about 947 kcal/L, and a third base formula having a caloric density of from about 981 to about 1082 kcal/L.

11. An infant formula feeding kit according to claim 9 wherein the plurality of base infant formulas includes a first base formula having a caloric density of from about 620 to about 660 kcal/L, a second base formula having a caloric density of from about 790 to about 830 kcal/L, and a third base formula having a caloric density of from about 995 to about 1035 kcal/L.

12. An infant formula according to claim 9 wherein each of the base infant formulas comprises, per 100 kcal of formula,
(A) from about 120 to about 190 mg of calcium,
(B) phosphorous in a calcium to phosphorous mass ratio of from about 1.7:1 to about 2:1,
(C) from about 1 to about 2 mg of zinc,
(D) from about 100 to about 250 mcg of copper, and
(E) from about 30 to about 70 mg of sodium.

13. An infant formula according to claim 10 wherein each of the base infant formulas further comprises, per 100 kcal of formula: from about 120 to about 190 mg of calcium, phosphorous in a calcium to phosphorous mass ratio of from about 1.7:1 to about 2:1, from about 6 to about 17 mg of magnesium, from about 0.3 to about 4 mg of iron, from about 1 to about 2 mg of zinc, from about 6 to about 30 mcg of manganese, from about 100 to about 300 mcg of copper, from about 5 to bout 40 mcg of iodine, from about 35 to about 70 mg of sodium, from about 50 to about 200 mg of potassium, from about 50 to about 200 mg of chloride, from about 1 to about 6 mcg of selenium, from about 5 to about 30 mcg of fluoride, from about 200 to about 500 mcg of vitamin A, from about 50 to about 500 IU of vitamin D, from about 2 to about 30 mcg of vitamin K, from about 20 to about 400 mcg of thiamin, from about 50 to about 700 mcg of riboflavin, from about 400 to about 7000 mcg of niacin, from about 20 to about 300 mcg of pyridoxine, from about 0.05 to about 1.0 mcg of vitamin B12, from about 20 to about 50 mcg of folic acid, from about 200 to about 3000 mcg of pantothenic acid, from about 1 to about 50 mcg of biotin, and from about 5 to about 50 mg of vitamin C.

14. An infant formula feeding kit according to claim 10 wherein the device for calculating is selected from the group consisting of a programmed calculator, software program with a computer, nomograms, precalculated tables, precalculated charts, precalculated graphs, and combinations thereof.

15. An infant formula feeding kit according to claim 10 wherein the device for calculating is a graph, chart, or table containing precalculated blend volumes.

16. An infant formula feeding kit according to claim 10, wherein the device calculations are based on the blend equations:
V₁=[V_{f}×(D₂−D_{f})]÷(D₂−D₁)
V₂=V_{f}−V₁
wherein
V_{f}=final blend volume (liters)
D_{f}=final blend caloric density (kcal/L)
V₁=volume of the least calorically dense base selected (liters)
D₁=caloric density of least calorically dense base selected (kcal/L)
V₂=volume of the most calorically dense base selected (liters)
D₂=caloric density of most calorically dense base selected (kcal/L)
and wherein the volume of each selected base formula is selected from within 5% of the calculated values for V₁ and V₂.

17. An infant formula comprising
A) from about 25 to about 40 g/L of protein;
B) from about 56 to about 90 g/L of fat, of which from about 10% to about 90% by weight is a medium chain triglyceride oil; and
C) at least about 40 g/L of carbohydrate;
wherein the formula has a caloric density of from about 981 to about 1082 kcal/L and an osmolality of from about 280 to about 360 mOsm/kg water.

18. An infant formula according to claim 17 wherein the osmolality is from about 290 to about 350 mOsm/kg water.

19. An infant formula according to claim 17 wherein the caloric density is from about 1000 to about 1050 kcal/L.

20. An infant formula according to claim 17 wherein the fat comprises from about 25% to about 75% by weight of medium chain triglyceride oil.

21. An infant formula according to claim 17 wherein the fat comprises from about 35% to about 65% by weight of medium chain triglyceride oil.

22. An infant formula according to claim 17 wherein the protein comprises a protein hydrolyzate.

23. An infant formula according to claim 17 wherein the protein comprises protein hydrolyzate and additional free amino acids.
